(19) United States
(12) Patent Application Publication
(10) Pub. No.: US 2003/0072919 A1
(43) Pub. Date: Apr. 17, 2003

(54) Surface covering having differential gloss in-register and method of making

(76) Inventors: Frank Watts JR., McElhattan, PA (US); Gary A. Sigel, Millersville, PA (US); William J. Kauffman, Manheim, PA (US)

Correspondence Address: Womble Carlyle Sandridge & Rice, PLLC, P.O. Box 7037, Atlanta, GA, 30357-0037, US

(21) Appl. No.: 09/951,373

(22) Filed: Sep. 13, 2001

(51) Int. Cl. B32B 3/00; B32B 7/14; B32B 5/18; B32B 31/14; B32B 27/14

(52) U.S. Cl. 428/159; 428/172; 428/195; 428/160; 428/203; 156/79

(57) ABSTRACT

A surface covering and a method of manufacturing such surface covering is disclosed. In one embodiment of the present invention, the surface covering includes a film having a print layer forming a pattern or design disposed on one side of the film. A discontinuous gloss layer is disposed on the other side of the film substantially in-register with at least a portion of the printed pattern or design. Additionally, the gloss layer has at least one portion thereof which has a gloss level different from the side upon which the gloss layer is disposed. In another embodiment, the surface covering has a film and a discontinuous gloss layer disposed on one side of the film. The gloss layer forms a pattern or design and at least one portion thereof has a gloss level different from the side upon which the gloss layer is disposed. A surface texture is mechanically embossed into the film substantially in-register with the pattern or design of the gloss layer. Optionally, a web may be laminated to the surface covering.

### FIELD OF THE INVENTION

The present invention relates generally to the field of surface coverings. More particularly, the present invention relates to surface coverings having decorative gloss effects on an exposed surface thereof and a method of making such surface coverings.

### BACKGROUND OF THE INVENTION

For many decorative surface coverings, particularly in the flooring industry, the outermost coating may have a surface which has a high or low gloss appearance. For example, a matte or satin finish may be employed to provide a more natural appearance for decorative patterns, such as wood, slate, mosaic, brick, and other natural products, which have been printed onto a substrate. Typically, a low gloss or matte coating can enhance the appearance of such a decorative pattern. Further enhancement of such a decorative layer may be accomplished by utilization of both matte and glossy areas. Having both matte and glossy areas provide a more realistic visual or natural appearance of a natural product. However, the gloss level of the coating should be tailored for the individual pattern and complement not only the characteristics of the print pattern, but also any mechanically embossed texture thereon as well.

Composite flooring products have been produced in which the exposed surface of this filmless product has different gloss effects. Typically, production of the composite flooring product utilizes multiple coat cure stations consisting of a coater and ultraviolet (UV) medium pressure-mercury vapor lamps. The UV lamps typically have a long wavelength and a short wavelength output. To match the UV output of these sources, photoinitiators can be used to absorb UV light above 300 nm and below 300 nm. Microwave UV source lamps that exhibit characteristic spectral distributions above 300 nm, however, are more costly than standard medium pressure-mercury vapor lamps. Typically, ultraviolet glossy and/or matte coatings are required for this operation. Unfortunately, this process is difficult to control because it is dependent upon mechanical embossing tooling. Capital investment requirements in radiation cure equipment utilized to apply such coatings onto a decorative substrate can be significant. Additionally, some of these photoinitiators, commonly referred to as phosphine oxides, are costly, and in many instances, have the problem of leaving an undesirable yellow color to a cured final product. An example of one such flooring product is described in European Patent Application No. EP 0 972 107 A1 to Chen et al.

Ishizawa et al. in U.S. Pat. No. 4,226,933 describe a method of manufacturing a decorative panel consisting of an embossed surface with different degrees of gloss within the embossed areas. The gloss effect is produced by utilizing a radiation curable coating and a translucent mask with transparent pattern areas to selectively cure certain areas of the pattern while leaving the other areas incompletely cured. The coating under the transparent areas of the mask cures rapidly upon exposure to UV radiation, while the coating under the translucent areas of the mask cures at a slower rate. The addition of a peroxide catalyst facilitates the curing of the coating in these areas, resulting in low gloss areas that conform to a pattern impressed on the pigment-containing sheet. A relatively long UV exposure time of 10 minutes is required to cure the non-masked areas. Multiple film layers are also required for this process, and such layers must be laid onto to the photocurable coating without producing bubbles under the film.

Resinous polymer sheet materials consisting of selective surface decorative effects is discussed in U.S. Pat. No. 4,248,922 to Shortway et al. The sheet materials are formed by cross-linking textured/lower gloss regions of a coating to maintain texture/lower gloss. The non-cross-linked regions of the coating become smooth and glossy upon further processing, such as by heating.

Despite existing methods of making floor coverings which have differential gloss effects on coatings, there is a need for a surface covering which has a differential gloss effect printed onto a film which is in-register with a printed or a mechanically embossed pattern or design thereon. Further, there remains a need for a method of making such a surface covering. It is to the provision of a surface covering having a differential gloss in-register and method of making that meets these needs that the present invention is primarily directed.

### SUMMARY OF THE INVENTION

Briefly described, the present invention comprises a surface covering and a method of manufacturing such surface covering. In one aspect of the present invention, the surface covering comprises a film having a print layer comprising a pattern or design disposed on a first side thereof. A discontinuous gloss layer is disposed on a second side of the film substantially in-register with at least a portion of the printed pattern or design. Additionally, the gloss layer has at least one portion thereof comprising a gloss level different from the second side.

Another aspect of the present invention relates to a surface covering that comprises a film and a discontinuous gloss layer disposed on one side of the film. The gloss layer comprises a pattern or design and at least one portion of the gloss layer has a gloss level different from the side of the film upon which it is disposed. A surface texture is mechanically embossed into the film substantially in-register with the pattern or design of the gloss layer.

Yet, another aspect of the present invention relates to a surface covering comprising a web, a film disposed on the web, and a print layer comprising a printed pattern or design is disposed on one side of the film adjacent the web. On the other side of the film is a discontinuous gloss layer which is substantially in-register with at least a portion of the printed design or pattern. At least one portion of the gloss layer comprises a gloss level different from the side upon which it is disposed.

Still, another aspect of the present invention relates to a surface covering comprising a film, a web disposed on one side of the film, and a discontinuous gloss layer comprising a gloss pattern or design disposed on the other side of the film. The gloss layer has at least one gloss level different from the side upon which it is disposed. At least one surface texture is mechanically embossed into the film substantially in-register with the gloss pattern or design.

Further, another aspect of the present invention relates to a method of manufacturing a surface covering comprising forming or supplying a film, applying a print layer comprising a pattern or design on one side of the film, and applying a discontinuous gloss layer on the other side of the film. The gloss layer is substantially in-register with at least a portion of the printed pattern or design and has at least one portion thereof comprising a gloss level different from the side upon which it is disposed.

Still further, another aspect of the present invention relates to a method of manufacturing a surface covering comprising forming or supplying a film, applying a discontinuous gloss layer comprising a pattern or design on a side of the film, and mechanically embossing and setting at least one surface texture into the film, the gloss layer, or both. At least one portion of the gloss layer comprises a gloss level different from the side upon which it is disposed.

Thus, a unique surface covering and method of manufacturing such surface covering is now provided that successfully addresses the shortcomings of and provides distinct advantages over existing surface coverings and their methods of manufacture. Additional objects, features, and advantages of the invention will become more apparent upon review of the detailed description set forth below when taken in conjunction with the accompanying drawing figures, which are briefly described as follows.

### BRIEF DESCRIPTION OF THE DRAWINGS

FIG. 1 is a partial side view of an embodiment of a surface covering made in accordance with the present invention illustrating a gloss layer on one side of a film and a print layer on the other side of the film.

FIG. 2 is a partial side view of another embodiment of the surface covering made in accordance with the present invention illustrating mechanical embossed textures in-register with the gloss layer.

FIG. 3 is a partial side view of yet another embodiment of the surface covering made in accordance with present invention.

FIG. 4 is a partial side view of still another embodiment of the surface covering made in accordance with the present invention.

FIG. 5 is a schematic view of a method of manufacturing the surface covering in accordance with the present invention.

FIG. 6 is a schematic view of another embodiment of manufacturing the surface covering in accordance with the present invention.

FIG. 7 is a schematic view of yet another embodiment of manufacturing the surface covering in accordance with the present invention.

FIG. 8 is a schematic view of still another embodiment of manufacturing the surface covering in accordance with the present invention.

### DETAILED DESCRIPTION OF THE INVENTION

For a more complete understanding of the present invention, reference should be made to the following detailed description taken in connection with the accompanying drawings, wherein like reference numerals designate corresponding parts throughout the several figures.

Referring first to FIG. 1, there is shown a partial view of an embodiment of a surface covering 10 made in accordance with the present invention. In this embodiment, the surface covering 10 comprises a film 12 having a first and a second side 14 and 16. A print layer 18 comprising a pattern or design is disposed on the first side 14. On the second side 16, a discontinuous gloss layer 20 is disposed on the film 12 substantially in-register with at least a portion of the printed pattern or design of the print layer 18. The gloss layer 20 has at least one portion thereof comprising a gloss level different from the second side 16 of the film 12. Depending upon the desired gloss effect, the gloss layer 20 optionally can comprise portions which have gloss levels different from one another. Thus, the gloss layer 20 of the present invention, including the embodiments discussed below, is not limited to a single gloss level. Further, a surface texture, generally indicated at 22a and/or 22b, may be mechanically embossed into the surface covering 10. The surface texture may be substantially in-register with the pattern or design of the gloss layer 20 as well. As indicated in area 24, texture 22a is mechanically embossed into the film 12. In area 26, texture 22b is mechanically embossed into the surface covering 10 through the gloss layer 20. Multiple surface textures may be employed with the present invention. For example, texture 22a of area 24 can be the same as or different from texture 22b of area 26.

Now, referring to FIG. 2, this embodiment of the surface covering 10 comprises the film 12 and the discontinuous gloss layer 20 disposed on the second side 16 of the film 12. The gloss layer 20 is disposed onto the film 12 to form a pattern or design. Again, at least one portion of the gloss layer 20 has a gloss level different from the second side 16, but may comprise portions which have gloss levels different from one another. As described above, the surface texture 22 is mechanically embossed into the surface covering 10 which is substantially in-register with the pattern or design of the gloss layer 20. As indicated in area 24, texture 22a is mechanically embossed into the film 12. In area 26, texture 22b is mechanically embossed into the surface covering 10 through the gloss layer 20. Multiple surface textures may be employed with the present invention. Again, texture 22a of area 24 can be the same or different from texture 22b of area 26. Optionally, a web 28 may be laminated or affixed to the first side 14 of the film 12. The web 28 can comprise single or multiple layers and is described further below.

Referring to FIG. 3, this embodiment of the surface covering 10 comprises the film 12 and the print layer 18, which forms a pattern or design, disposed on the first side 14. On the second side 16, the discontinuous gloss layer 20 is disposed on the film 12 substantially in-register with at least a portion of the printed pattern or design of the print layer 18. As indicated above, the gloss layer 20 has at least one portion thereof comprising a gloss level different from the second side 16 of the film 12. Further, depending upon the desired gloss effect, the gloss layer 20 can comprise portions which have gloss levels different from one another. Laminated or affixed to the first side 14 of the film 12 and/or print layer 18 thereon is the web 28. As indicated above, the web 28 can comprise single or multiple layers. Additionally, the second side 16 and/or gloss layer 20 thereon may be mechanically embossed to place one or more textures 22 respectively thereon. As illustrated in FIG. 3, the surface textures 22c, 22d, and 22e may be mechanically embossed substantially in-register with the gloss layer 20. In area 30, for example, texture 22c is mechanically embossed into the film 12 and the web 28 in a location devoid of either the print and gloss layers 18 and 20. Texture 22d of area 32 is mechanically embossed into the film 12 and the web 28 at a location devoid of the gloss layer 20, but substantially in-register with the pattern or design of the print layer 18. Still, in area 34, texture 22e is mechanically embossed into the gloss layer 20, film 12, print layer 18, and the web 28.

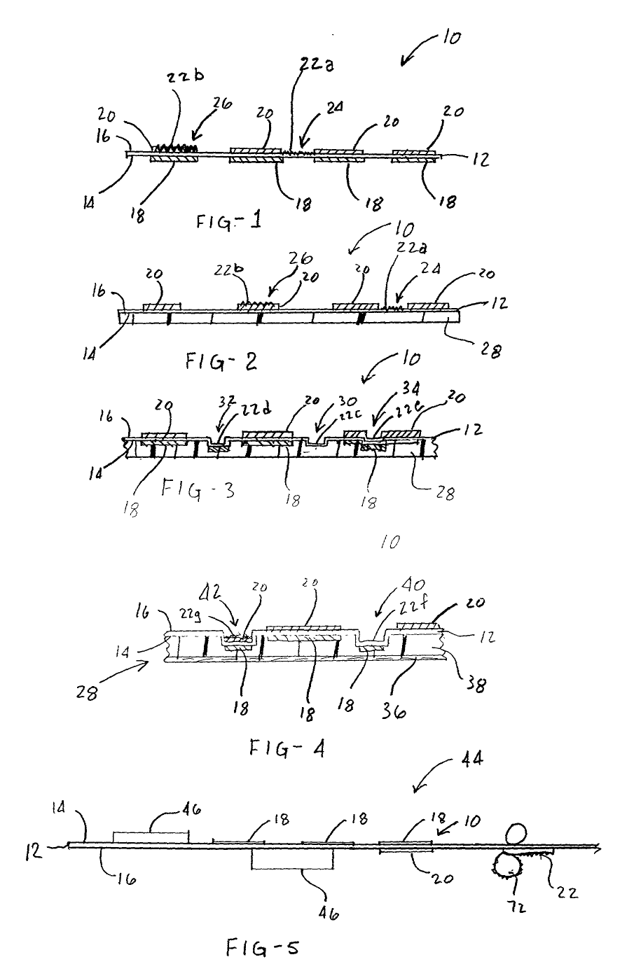

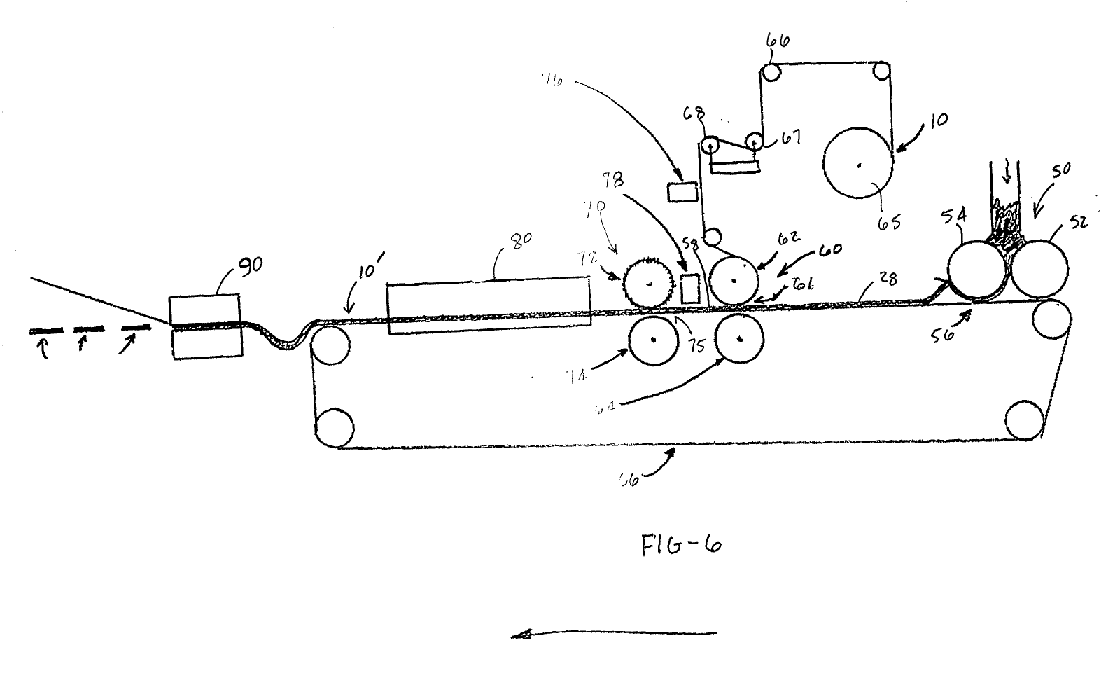

Now, referring FIG. 4, this embodiment of the surface covering 10 comprises the film 12 and the print layer 18, which forms a pattern or design, disposed on the first side 14. On the second side 16, the discontinuous gloss layer 20 is disposed on the film 12 substantially in-register with at least a portion of the printed pattern or design of the print layer 18. As indicated above, the gloss layer 20 has at least one portion thereof comprising a gloss level different from the second side 16 of the film 12. Further, depending upon the desired gloss effect, the gloss layer 20 can comprise portions which have gloss levels different from one another. Laminated or affixed to the first side 14 of the film 12 and/or print layer 18 thereon is the web 28. In this embodiment, the web 28 comprises a substrate 36 and a foam layer 38. The foam layer 38 has a chemically embossed pattern or design 40. Additionally, the second side 16 and/or gloss layer 20 thereon may be mechanically embossed to place one or more surface textures respectively thereon as discussed above. As illustrated in FIG. 4, the surface textures 22f and 22g may be mechanically embossed substantially in-register with the gloss layer 20. In area 40, for example, texture 22f is mechanically embossed into the film 12 and the web 28 at a location devoid of the gloss layer 20, but substantially in-register with the pattern or design of the print layer 18. In area 42, for example, texture 22g is mechanically embossed into the gloss layer 20, film 12, print layer 18, and the web 28.

In accordance with the present invention and as illustrated in FIGS. 1-4, a non-continuous, mechanically embossed texture 22 is substantially in-register with the gloss layer 20 whether the texture 22 is either adjacent to or overlapping a portion of the discontinuous gloss layer 20. Further, a continuous mechanically embossed texture 22 disposed across the film 12 and gloss layer 20 thereon may be employed with and is a part of the present invention.

For example, the surface covering 10 can be formed from a rigid vinyl film 12 having a thickness of about 1.5 to about 3 mils. Rigid vinyl film is a term of art which means a polyvinyl chloride film having fewer than 5 parts plasticizer per hundred parts by weight of resin (phr). As indicated above, the rigid vinyl film 12 is fed into a multi-station ink press line to print the print layer 18 comprising a printing ink on the first side 14 to form the decorative pattern or design. A low gloss varnish composition comprising an organic-based acrylic polymer is selectively printed in-register with the pattern or design of the print layer 18 onto the second side 16 by a gravure cylinder and dried in the printing station. The temperature of the printing ovens should be kept below the glass transition temperature of the film 12, below about 176° F. for rigid vinyl films, but warm enough to remove solvent from the inks and low gloss varnish. Temperature profiles of a nine print station process, the first eight printing the print layer 18 and the ninth station applying the gloss layer 20, is as follows:

| | 1 | 2 | 3 | 4 | 5 | 6 | 7 | 8 | 9 |
|---|---|---|---|---|---|---|---|---|---|
| first | 120 | 120 | 120 | 120 | 120 | 120 | 120 | 120 | 140 |
| side 14 | | | | | | | | | |
| second | 140 | 140 | 140 | 140 | 140 | 140 | 140 | 140 | 140 |
| side 16 | | | | | | | | | |

Thereafter, the acrylic polymer is heated above its melting temperature, such as during lamination, to form a non-continuous, hard coating between about 0.1 to 0.6 mils in thickness and having a matte gloss. Finally, the surface covering 10 may be punched into tiles, such as 12″×12″ tiles. Gloss levels of the present invention are measured by a 60 degree gloss meter in accordance with ASTM Standard D 523-89. In one embodiment of the present invention, the gloss layer 20 has a gloss level from about 4 to about 50, and the second side 16 of the film 12 has a gloss level from about 65 to about 100. In another embodiment, the gloss level of the second side 16 has a gloss level from about 45 to about 60.

The film 12 employed with the present invention may be formed in any conventional manner, such as, extrusion, calendering, and casting techniques. Films which may be employed with the present invention include, but are not limited to, a film comprising a material selected from a polyvinyl chloride, a polyurethane, a polyester, a polyamide, a polyolefin, a polyacrylate, and co-polymers thereof. Polyolefin film materials include both the Ziegler-Natta and the metallocene types, as well as a high density polyethylene, a low density polyethylene, a linear low density polyethylene, a polypropylene (both clarified and syndiotactic), a polyethylene-polypropylene co- or ter-polymer, a polystyrene-polyethylene co-or ter-polymer, and cyclic polyolefins. Polyvinyl chloride film materials include homo-and co-polymers (rigid and elastomeric). Polyester film materials include a copolyester, a polyethylene terephthalate, a glycol modified polyethylene terephthalate, and a thermoplastic polyester. Polyurethane film materials include thermoplastic polyurethanes, such as those based upon aliphatic isocyanates, polyether, or polyester. Acrylic film materials include a polymethyl methacrylate, a polymethacrylate, and an ethylene vinyl acetate.

Further, the film 12 in accordance with the present invention includes films comprising multiple layers which may be the same or different from one another. Such films can be formed by multiple layer extrusion and include polylefin composite films comprising polyethylene, polypropylene, functionalized polyolefins, such as maleic anhydride grafted polyethylene or polyethylene-ethylene acrylic acid co-polymers, and ethylene vinyl acetate, to name only a few. Other multiple layer films may be formed by coating existing films with a solvent or water based coating material, such as a plasticsol or an organisol, and 100% solids based coatings. Such coatings are solidified by drying, curing, and the like, depending upon the coating chemistry and properties of the film being coated. Such coating materials may be a thermoplastic or a thermoset. Examples include, but are not limited to, polyvinyl chloride/urethane and polyvinyl chloride/polyester films. Further, multiple layer films can be formed by melt coating a melt processible polymeric material onto an existing film. Still, multiple layer films include laminated films.

The gloss layer 20 is typically formed from materials which exhibit many performance properties of surface coverings, such as flooring products, that are consistent and/or compatible with the film 12. Such properties include, to name only a few, resistance to cleaning agents and household stains, abrasion resistance, and heat and light stability. Also, the surface covering 10 comprising the film 12, the gloss layer 20, and the print layer 18, if present, can be formed from materials which can be wound on a roll or laminated to the web 28 without exhibiting cracking of the gloss layer 20. Likewise, the web 28 can be formed from materials which can be wound on a roll. Materials for the gloss layer 20 which may be employed in the present invention include traditional solvent based, water based, and 100% solids UV/EB coating/ink materials. Thus, curing of the printed gloss layer 20 should occur in the printing process or as part of the film lamination and surface covering 10 manufacturing process. For example, an UV curable coating should be exposed to UV radiation curing conditions which permit processing as well as development of physical performance. Such materials include, but not limited to, epoxy based coatings, melamine cured coatings, such as those described in U.S. Pat. No. 5,643,677, incorporated herein in its entirety by reference, acrylics, urethanes, such as those described in U.S. Pat. No. 5,003,026, which is incorporated herein in its entirety by reference, surlyn/ionomer dispersions, UV/EB curable coatings, such as those described in U.S. Pat. No. 5,891,582, which is incorporated herein in its entirety by reference, and organic/inorganic coatings, such as those described in U.S. Pat. No. 5,120,811, which is incorporated herein in its entirety.

Further, the gloss layer 20 can include flatting or matte agents typically comprising minute particles of irregular shape which disperse incident light rays so that a dull, flat, or matte effect is produced. Examples of flatting agents are heavy-metal soaps, finely divided silica, and diatomaceous earth, to name only a few. Additionally, flatting agents include wear resistant fillers, such as aluminum oxide in all forms, including calcine, crystalline, precipitated, semi-, micro-, and non-crystalline, amorphous, and other types known in the art; spinel; aluminum phosphate; titanium; titania; urea-formaldehide compositions (such as those marketed under the trademark PERGOPAK M-3 by Lonza, Inc.); diamond; boron nitride; and other hard particulates as known in the art. Such wear resistant fillers also provide enhanced scratch resistance to the gloss layer 20 after curing thereof. Other wear resistant fillers as known in the art may be employed. Examples of other flatting agents which may be employed with the present invention include those described in U.S. Pat. Nos. 3,943,080, 3,948,839, and 4,263,051, which are incorporated herein in their entirety by reference.

The web 28 of the present invention can be utilized to form sheet vinyl, polyolefin, and like material surface coverings, as well as individually cut tiles. Also, the web 28 can be reinforced with either organic fibers such as cellulose, or inorganic fibers such as glass, polyester, or acrylic. Additionally, the web 28 can include multiple layers, including a substrate 36, the foam layer 38, and/or a vinyl mixture which comprises at least a vinyl resin, a plasticizer, and a filler.

In the present invention, for purposes of creating the foam layer 38 of the web 28, including the chemically embossed foam layer 38, the web 28 comprises the expandable and resinous foam layer 38 containing a foaming or blowing agent. The print layer 20, which can form a printed pattern or design, is provided over at least a portion of the second side 16 of the film 12. A plurality of print layers 20 can be disposed on the film 12. Although not required in the present invention, the print layer 20 can comprise an inhibitor or an accelerator composition to provide a chemically embossed pattern in the foam layer 38, if desired. Additionally, an inhibitor or an accelerator composition can be printed onto the foam layer 38 in addition or alternatively to such a composition in the print layer 20. As described above, once the film 12 is applied on top of the foam layer 38 with the print layer 20 in operable contact with the expandable foam layer 38, the expandable foam layer 38 can be subjected to a sufficient temperature for a sufficient time to expand such layer. As a result, the chemically embossed region or pattern proximate the portion of the printed design containing the foaming or blowing agent inhibitor or accelerator is formed. Generally, a sufficient temperature is from about 350° F. to about 400° F. and for a time of from about 0.8 minute to about 3 minutes to expand the foam layer 38. It should be understood, however, that the inhibitor or the accelerator can be applied at random rather than as an exact reproducible design. Further, it is not required for the inhibitor or the accelerator to be in direct contact with the expandable foam layer 38.

The foam layer 38 of the present invention can be any conventional foam layer used in surface coverings, such as a foam layer used in flooring and wall covering products. In particular, the foam layer 38 can be any suitable material known in the art for producing foam layers such as a fluid or semi-fluid plastisol or organosol composition. Generally, the composition of the foam layer 38 is a plastisol or organosol composition of a thermoplastic polymer or homopolymer of polyvinyl chloride, or a copolymer, block polymer, or graft polymer of polyvinyl chloride and one or more other co-polymerizable resins such as vinyl acetate, vinyl propionate, vinyl butyrate, vinylidene chloride, alkyl acrylates and methacrylates, and the like. Other compositions of thermoplastic resins, such as polyamides, polyesters, polyolefins, polystyrene, polycarbonates, acrylics, and the like may be utilized to form the foam layer 38 of the present invention. Additionally, a cross-linked resin system may be employed as long as such resin system can be chemically embossed and cured.

In one embodiment, the foam layer 38 is a resilient, cellular foam layer formed from a resinous composition containing a foaming or blowing agent that causes the composition to expand on heating. It is also known in the art that foamable, resinous sheet material can be selectively embossed by controlling the decomposition temperature of a catalyzed blowing or foaming agent in the heat-expandable composition. For example, by effectively applying a reactive chemical compound referred to in the art as an inhibitor, regulator, retarder, or accelerator, collectively referred to herein a chemical embossing agents, to the heat-expandable composition, it is possible to modify the decomposition temperature of the catalyzed foaming or blowing agent in the area of application of the reactive compound. It is thus possible to produce sheet materials having surface areas that are depressed with inhibitor application and raised proximate the area without inhibitor application.

While the foam layer 38 may be applied as a coating to the substrate 36, the foam layer 38 can also be applied as a preformed sheet or the composition can be molded, extruded, calendered, or otherwise formed into any desired shape depending on the ultimate use of the product.

As indicated above, the expandable resinous composition comprising the foam layer 38 includes an effective amount of a foaming or blowing agent. The larger the amount of blowing agent within practical limits used, the greater is the expansion of the foam. Foaming or blowing agents are well known in the art and the particular blowing agent selected usually depends on such matters as cost, resin, and desired foam density. Complex organic compounds which, when heated, decompose to yield an inert gas and have residues which are compatible with the resin are preferred as foaming or blowing agents. Such materials should have the property of decomposition over a narrow temperature range which is particularly desirable to obtain a good foam structure. Examples of typical foaming or blowing agents include without limitation substituted nitroso compounds, substituted hydrazides, substituted azo compounds, acid azides, and guanyl compounds, to name only a few. Foaming or blowing agents for use in the present invention must be decomposed an effective amount at a temperature below the decomposition temperature of the resinous compositions, film 12, gloss layer 20, and web 28, including the substrate 36, of the surface covering 10. In one embodiment of the present invention, foaming or blowing agents are employed which decompose above the elastomeric point of the resin composition of the foam layer 38, thereby permitting at least partial gelling of the foam layer 38. As a result, the film 12 can be laminated to the surface of the foam layer 38. Additionally, accelerators or catalysts can be added to the resinous composition of the foam layer 38 to accelerate the decomposition of the blowing agents, reduce the decomposition temperature, act as stabilizers for the resinous composition, and/or narrow the decomposition temperature range. Such accelerators and catalysts are known in the art. Further discussion of foaming or blowing agents is provided in U.S. Pat. No. 3,293,108, column 11, line 37 to column 12, line 24. Also, the resinous composition can include solvents, viscosity modifiers, color and UV stabilizers, and the like.

The print layer 18 can be formed from a printing ink composition. As indicated above, the printing ink composition may or may not include at least one chemical embossing agent, such as an inhibitor or an accelerator composition. The area or portions of the print layer 18 comprising the printing ink composition without inhibitor will not inhibit expansion of the foam layer 38. Printing ink compositions usually comprise resins, plasticizers, solvents, pigments, stabilizers, dyes, accelerators, promoters, kickers, and the like. They are applied by the conventional printing apparatus discussed above and below and are usually very thin, only a fraction of a mil. To inhibit expansion of the foam layer 38, the blow or foam modifying agents, also referred to herein as the chemical embossing agents, such as inhibitors, regulators, retarders, suppressants, accelerators, and the like, are added to the printing ink composition. Drying is usually conducted within the printing unit and can be accomplished by exposure to air or by conventional heating and drying procedures. An example of such an ink composition contains an acrylic resin, water, alcohol, and one or more pigments.

In forming a design having both an inhibitor composition and one not containing a inhibitor composition, such a design can be done in-register using multiple station rotogravure printing, as described in U.S. Pat. Nos. 3,293,108, 4,147,104, and 4,264,957, which are incorporated herein in their entirety by reference. For example, the print layer 18 can form a pattern of joint or grout lines which are created with at least one inhibitor composition. Upon expansion of the foam layer 38, these portions will be chemically embossed and will visually form joint or grout lines to simulate such lines which exist with natural wood, stone, slate, marble, granite, brick, mosaic, tile surfaces, and the natural appearance of other natural products. The joint or grout lines created with the inhibitor composition generally will have a width of, for example, from about 0.125 inch to about 0.25 inch.

The inhibitor can be conveniently incorporated in an inhibitor composition, preferably incorporated in the printing ink composition to form a foam-retarding, printing ink composition, which is printed onto the film 12. Such compositions are well known in the art and are generally based on an organic solvent carrier or vehicle system. Foaming or blowing agent inhibitors or modifiers include, but are not limited to, tolyltriazole, benzotriazole, fumaric acid, malic acid, hydroquinone, dodecanethiol, succinic anhydride, and adipic acid. Examples of printing ink compositions useful with the present invention are described in U.S. Pat. Nos. 5,169,435 to Sherman et al., 4,191,581 and 4,083,907 to Hamilton, 4,407,882 to Houser, and 5,336,693 to Frisch. Further discussion of inhibitors is also provided in U.S. Pat. No. 3,293,108 to Nairn et al., column 14, line 38 to column 17, line 47.

The substrate 36 of the present invention can be any conventional substrate, carrier, or backing layer used in surface coverings. Its selection depends in large measure on the product to be produced. For example, in one embodiment of the invention, the substrate 36 remains as a part of the surface covering 10. Accordingly, the substrate 36 can be formed of a resinous composition, a woven, knitted, or non-woven fabric, a paper product, a felted or matted fibrous sheet of overlapping, intertwined natural, synthetic, or man-made cellulosic filaments and/or fibers, and other forms of sheets, films, textile materials, fabrics, and the like. In addition, any thermoplastic or elastomeric resinous composition which can be formed into a sheet may be utilized as the substrate 36. These resins typically can be compounded with plasticizers and fillers and sheeted to form the substrate 36. Such resins include, but are not limited to, butadiene-styrene copolymers, polymerized chloroprene, and the like. Also, the substrate 36 can be a non-foamed, non-crosslinked vinyl composition such as polyvinyl chloride, polyvinyl acetate, and vinyl chloride-vinyl acetate copolymers. Additional substrates 36 useful with the present invention are also discussed in U.S. Pat. No. 3,293,108 to Nairn et al., which is incorporated herein in its entirety. The thickness of the substrate 36 is generally not critical and it is from about 5 mils to about 150 mils. In an another embodiment of the present invention, the substrate 36 has a thickness from about 10 mils to about 80 mils.

The web 28 can comprise the substrate 36 coated with a hot melt calendered (HMC) layer manufactured by a HMC process. HMC refers to the process of formulating a homogeneous mixture containing a hot melt processable resin and preferably plasticizer, stabilizer, filler, and other ingredients, heating the mixture, and delivering the heated mixture to a calender where the mixture is applied in a precisely controlled thickness to the substrate 36 to form a laminated substrate. Although the substrates 36 mentioned above are suited for the HMC process, the preferred substrates 36 in the HMC process are felt or polyester sheet. Such melt processable resins include, but are not limited to, polyvinyl chloride (including general purpose polyvinyl chloride as defined in ASTM Standard D1755-92), polyethylene, polypropylene, polystyrene, and copolymers thereof. Examples of fillers include, but are not limited to, mineral fillers, such as clay, talc, dolomite, and limestone. Respective amounts of plasticizer, fillers, and/or other ingredients, in the HMC layer can be varied in accordance with the desired physical properties of the HMC layer, such as, stiffness, percent elongation, tensile strength, etc.

The constituents of the HMC layer are mixed in a mixer (not shown), and fed into a calender (not shown) at a desired mix temperature. The calender nip (not shown) opening of the calender is adjusted to the desired thickness of HMC layer and the HMC layer is melt-coated directly onto the substrate 36 by bringing the substrate 36 into contact with a calender transfer roll (not shown) in a continuous process to form a laminated HMC substrate. The HMC substrate can also be produced by bringing the HMC layer into contact with the heated substrate 36 downstream from the calender.

In one embodiment, the foam layer 38 is applied to a substrate 36 and gelled as described below. The constituents of the HMC layer are processed in a high intensity mixer (not shown). The HMC layer is calendered to the desired thickness, brought into contact with one side of the substrate 36, and coated thereon to form a HMC substrate. Thereafter, the foam layer 38, an inhibitor or an accelerator composition, which can be disposed within the print layer 18 on the film 12, and the film 12, if desired, can be laminated onto either the HMC layer or the exposed substrate 36 as previously described. Thus, the substrate 36 either can be exposed or an internal structure not visible to the customer.

If the backing is to be removable, a release paper may be employed as the substrate 36. Such paper conventionally has a coating on its surface to allow the plastic sheet to be easily stripped from the paper. Typical coatings used are clays, silicone compositions, polyvinyl alcohol, and similar compositions known in the art. Additionally, an adhesive layer can be disposed on the surface covering adjacent the release paper.

Optionally, besides the layers discussed above, one or more additional layers can be present in the web 28, such as the layers described in U.S. Pat. No. 5,458,953, incorporated herein in its entirety by reference. Such additional layers include strengthening layers, additional foamable layers, and a wear layer base coat. The composition of these layers and their locations are described in U.S. Pat. No. 5,458,953 and can be used in the surface covering 10 of the present invention.

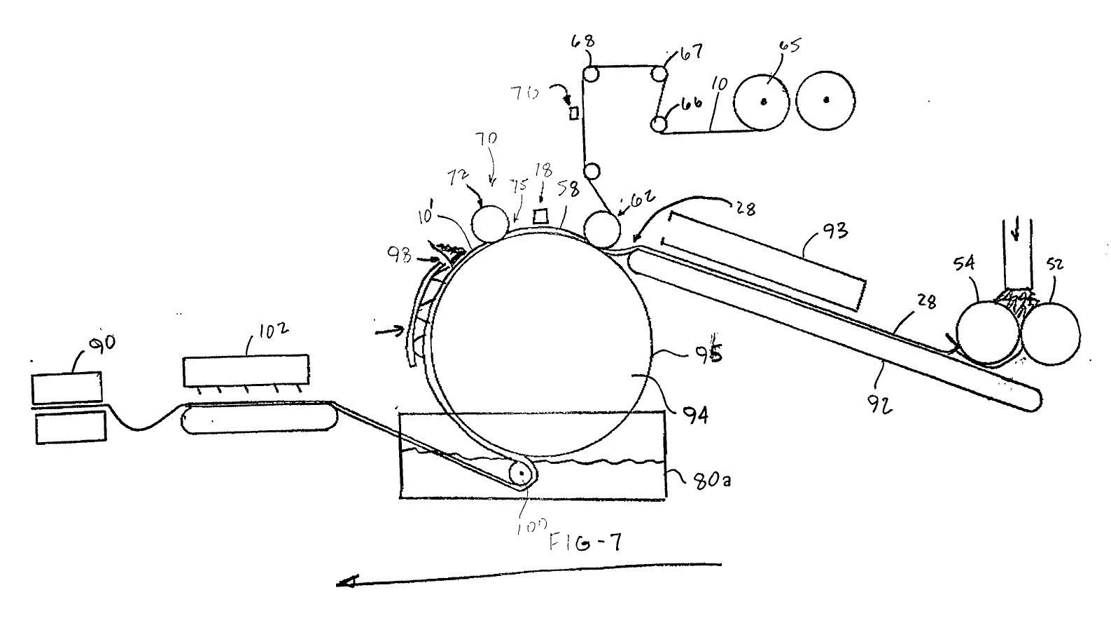

Referring to FIG. 5, there is shown a schematic view of a process generally indicated at 44 for producing a surface covering 10 in accordance with the present invention. As discussed above, in one embodiment of the process the print layer 18 is applied to the first side 14 the film 12 by one or more printing stations 46 to form a printed pattern or design. The film 12 is carried through the one or more printing stations 46 in a conventional manner. Likewise, the discontinuous gloss layer 20 is applied to the second side 16 of the film 12 by one or more printing stations 46 in-register with at least a portion of the printed pattern or design. As indicated above, the gloss layer 20 has at least one portion thereof comprising a gloss level different from the second side 16. From the printing stations 46, the surface covering 10 may be conventionally wound upon a roll or fed directly to a lamination process described below. Any conventional printing apparatus such as a silk screen apparatus, a flat bed printing machine, an ink jet printer, or a conventional gravure or rotogravure press which is etched to print a design with a suitable ink can be utilized to print on the film 12. The print layer 18 and the gloss layer 20 are conventionally dried in the printing unit 46. One or more of the printing ink compositions, which may be either pigmented or transparent, contain an inhibitor or an accelerator for the blowing agent in the foamable layer 38. Further, concentrations of inhibitor or accelerator can differ from one printing ink composition to another. Accordingly, the print layer 18 can be printed wherein the printing ink and inhibitor or accelerator composition vary from one portion or area to another.

With continued reference to FIG. 5, in another embodiment of the present invention, the print layer 18 is omitted from the film 12. Alternatively, the gloss layer 20 is printed on the second side 16 to form a printed pattern or design. At least a portion of the printed pattern or design of the gloss layer 20 has at least one portion thereof comprising a gloss level different from the second side 16. Thereafter, a mechanically embossed surface texture, generally indicated at 22 is placed onto the second side 16 and/or gloss layer 20 substantially in-register with the pattern or design of the gloss layer 20. Mechanical embossing is discussed further below. From the printing stations 46 or after being mechanically embossed, the surface covering 10 may be conventionally wound upon a roll or fed directly to a lamination process described below.

Now, referring to FIG. 6 with continued reference to FIG. 5, there is shown a schematic view of an embodiment of a process for producing a laminated surface covering 10′ in accordance with the present invention. A continuous hot melt base web 28 is prepared by blending its constituents comprising raw ingredients and, optionally, scrap from already formed surface coverings, such as tiles, sheet covering products, and the like, in blenders (not shown) and supplying the mix to a continuous mixer (not shown). For example, such a web 28 may be a vinyl mixture which comprises at least a vinyl resin, a plasticizer, and a filler. The vinyl mixture is conventional in the art and is typical of the vinyl compounds used to form conventional surface coverings, such as floor sheeting and tile. The hot melt is continuously supplied from the mixer to a calendar 50 comprising a pair of calendar rolls 52, 54 which produce the continuous hot melt base web 28. The thickness of the web 28 typically ranges from about 1 to about 3 mm. Other dimensions may be used in the practice of the present invention.

Hot plastic web 28 flows continuously onto a moving carrier belt 56 which is made of a material such that the web will adhere to the belt when the web 28 is hot, but can be easily removed when the web 28 is cool. For example, the carrier belt 56 can be made from a woven fiberglass impregnated with a silicone elastomer. Carrier belt 56 moves base web 28 through the lamination stage and, if desired, the embossing stage, supporting the web during these processing steps. The carrier belt 28 is conventionally driven by a drive roll (not shown) which is likewise conventionally known in the art. To avoid distorting the plastic web, a guidance system (not shown) is utilized to guide and align the web by performing continuous adjustment on the carrier belt. A loop speed sensor (not shown) is used to maintain the carrier belt 56 at a substantially constant speed as the hot melt web 28 leaves calendar rolls 52, 54.

Next, the hot web 28 enters a lamination section 60 that laminates surface covering 10 to web 28. For high-volume commercial production of surface coverings, such as tiles, the pattern or design of the print and/or gloss layers 18 and 20 may be one that permits tiles to be cut with the pattern or design centered in the tile so that it is in-register with the edges of the tile. Lamination section 60 comprises laminator rolls 62, 64, an optional supply roll 65, and guides 66, 67, and 68. The surface covering 10 is fed either from supply roll 65 or directly from the printing stations 46, through guides 66, 67, and 68 and through laminator rolls 62, 64. Guides 66 and 67 comprise pivot guides for the surface covering 10. The laminator rolls 62, 64 operate at sufficient pressures to provide adherence of the surface covering 10 to the web 28. Satisfactory adherence of the surface covering 10 to the web 28 and lamination is achieved when the rolls are operated at pressures of about 100 to about 300 psi.

To assist in proper alignment during lamination of the surface covering 10 in a transverse direction, an edge guidance system (not shown) is used. Moreover, conventional splicing equipment (not shown) may be employed to splice individual rolls of surface covering 10 to form one continuous roll at supply roll 65. The splicing equipment comprises an unwind roll stand, a splice table or auto splice mechanism, and a compensator that allows time to splice the printed design in-register. Alternatively, the printed design may be different and in-register splicing may not be necessary. Also, non-printed films 12 can be spliced and thereafter continuously printed and fed directly to the lamination section as discussed above.

Surface covering 10, web 28, and carrier belt 56 next pass through a laminator nip 61 formed by laminator rolls 62, 64 to form a laminate structure 58. As the web 28 enters the laminator nip 61, the web temperature is between about 320° F. to about 350° F. Due to the temperature of the web 28 and the pressure exerted in the laminator nip 61, the surface covering 10 is heated and stretches or elongates to some degree. Because the surface covering 10 has a wrap between about 45 to about 120 degrees on laminator roll 62, tension and the amount of stretch of the surface covering 10, the gloss layer 20, and the print layer, if present, thereon, may be controlled by the rotation rate of laminator roll 62. The rate at which the surface covering 10 is applied to the web 28 is defined as the film application rate. Typically, tension on the surface covering 10 is maintained at between about 1.5 to about 2 pounds per linear inch across the width of the surface covering (i.e., across machine direction (“PLI”). The film application rate is controlled by the rate at which laminator roll 62 rotates. Additionally, by wrapping the surface covering 10 around laminator roll 62, wrinkles are smoothed or “ironed out” of the surface covering 10 to provide a substantially flat laminate structure 58. Should the temperature of the web 28 be insufficiently high to provide sufficient lamination, heaters (not shown), such as infrared heaters, may be employed to raise the web temperature prior to entering the laminator nip 61. The temperature suitable for laminating the surface covering 10 to the web 28 is dependent upon the respective compositions, and may be adjusted accordingly. Further, an adhesive may be disposed between the surface covering 10 and the web 28 to facilitate lamination. Laminator roll 62 can be heated or cooled depending upon film material properties and composition. Typically, the temperature of the laminator roll 62 is maintained at about 90° F. for rigid vinyl films.

If one or more mechancially embossed textures are desired, the laminate structure 58 is then moved by the carrier belt 56 to an embossing section 70. The embossing section 70 comprises an embossing roll 72, a backup roll 74, such as a rubber backup roll, an embossing nip 75, a film scanner 76 for across machine direction control of surface covering 10 into the embossing nip 75, and a registration scanner 78 for embossing roll phase control and film repeat length control. Embossing roll 72 may be an engraved or etched steel roll having areas that are raised above the surface of the embossing roll 72. Typically, the difference in height between the raised areas and the surface of the embossing roll 72 averages about 0.25 to about 0.5 mm. Such raised areas may constitute an image of the pattern or design of print, if present, and/or gloss layers 18 and 20 that is printed onto the film 12. Both the embossing roll 72 and the backup roll 74 may be water cooled to set the mechanically embossed pattern into the laminate structure 58 and, additionally, to prevent sticking. Laminate structure 58 and belt 56 pass through the embossing nip 75 defined by embossing roll 72 and backup roll 74, with the surface covering 10 and the gloss layer 20 removably engaging the embossing roll 72. The raised areas of the embossing roll 72 form corresponding depressions in the film 12 and/or the gloss layer 20 of the laminate structure 58.

The outer surface of embossing roll 72 may be cooled directly by a water spray (not shown) or by internal cooling. Cooling the embossing roll 72 surface cools and sets the mechanically embossed pattern into the surface covering 10 of the laminate structure 58 to form surface covering 10′.

After passing through the embossing nip 75, surface covering 10′ is cooled to a temperature sufficient to allow surface covering 10′ to be stripped from carrier belt 56. This cooling operation may be accomplished by immersing surface covering 10′ and belt 56 in a water bath 80. After immersion, excess water is removed from the web, such as by a high velocity air knife (not shown) and surface covering 10′ is stripped from carrier belt 56. Thereafter, surface covering 10′ may be cut into tiles in a punch press 90 or tile cutter (not shown). Surface covering 10′ is aligned and cut into tiles in-register with the pattern printed on the film 12.

Referring now to FIG. 7 with continued reference to FIG. 5, another embodiment of the method of the present invention is illustrated. With the exception that this embodiment does not employ backup rolls 64 and 74 and the carrier belt 56, the method described above is fully employed in and is a part of this embodiment. The details of the present invention discussed above are incorporated here by reference and not repeated here for brevity. The web 28, such as a vinyl web, is prepared as described above and calendered onto a conveyor 92 by calender rolls 52, 54 at a temperature of about 300° F. to about 340° F. at about 1 to about 3 mm thick. The web 28 is transferred from the conveyor 92 to the surface 95 of the upper portion of a large drum 94. Prior to engaging the drum 94, a heater 93, such as an infrared heater, may be employed to heat the web 28 to a temperature between about 320° F. to about 350° F. One surface of the web 28 engages the drum surface 95 at about the one o'clock position of the drum 94. The drum surface 95 is maintained at a temperature of about 180° F., plus or minus about 30° F., due to passage of cooling water that is temperature controlled through the interior of the drum 94. The temperature of the drum 94 is what is referred to as an appropriate “stick range” for good adherence of the web 28 to the drum surface 95. Vinyl compound, for example, will tend to stick to a heated surface and will not shift relative to the heated surface when some type of processing step is performed on the vinyl. If the temperature is too low, there will be movement of the vinyl relative to the surface that it is carried on when some type of operation is performed on the vinyl, for example, an embossing step. If the temperature is too high, the vinyl becomes very fluid and cannot be operated on by a conventional step for modifying the surface of a surface covering, for example, an embossing step.

Shortly after the sheet is positioned on the drum surface 95, it is engaged indirectly by at least one laminator roll 62. The laminator roll 62 does not directly engage the web 28 because the surface covering 10 having a printed design thereon is inserted between the laminator roll 62 and the exposed surface of the web 28 on the drum surface 95. The drum 94 and the laminator roll 62 form the laminator nip 61. In the laminator nip 61, the web 28 and the surface covering 10 are laminated together to form the laminate structure 58. The temperature of the web 28 should be sufficiently high to provide bonding between the surface covering 10 and the web 28. It is possible that a single roll may be used and that a lamination and embossing step carried out by the one roll.

Next, as the drum 94 rotates, the composite structure 58 moves to the embossing section 70 which comprises the embossing roll 72 and the embossing nip 75. The embossing nip 75 is formed by the embossing roll 72 and the drum 94. As the laminate structure 58 passes through the embossing nip 75, the surface covering 10 removably engages the raised areas of the embossing roll 72 and a surface texture is mechanically embossed into the composite structure 58 as described above to form surface covering 10′.

Surface covering 10′ now moves counterclockwise with the surface 95 of the drum 94. Laminating and embossing are carried out about the 11-12 o'clock position on the drum 94. Surface covering 10′ now moves from the 11 o'clock position down to approximately the 7 o'clock position with the drum surface 95. While the surface covering 10′ is moving downward with the surface of the drum 94, there is sprayed/poured cooling water 98 primarily on the surface of the film 12 of surface covering 10′. This cools the film side of the surface covering 10′ to about 150° F. or a temperature that is below the glass transition temperature of the vinyl film to set the mechanically embossed pattern. The cooling of the film surface is carried out without substantially cooling the drum surface 95.

Near the bottom of the large drum 94, surface covering 10′ is removed from the drum 94 because the adherence of the web side of surface covering 10′ to the drum surface 95 has diminished to permit easy release of surface covering 10′ therefrom. Surface covering 10′ passes around roll 100 and falls into a water bath 80a as it leaves the drum surface 95 to keep the film 12 below its glass transition temperature. Thereafter, an air doctor 102 may be employed to assist in removing water from surface covering 10′ and subsequently, cut into tiles by the punch press 90. A more detailed discussion of the drum 94 is disclosed in U.S. Pat. No. 4,804,429, which in incorporated herein in its entirety by reference.

Methods of maintaining registration of a mechanically embossed texture with a pattern or design of a surface covering known in the art may be employed with the present invention. For example, such methods are discussed in U.S. Pat. Nos. 4,225,374, 4,773,959, 5,122,212, 5,304,272, which are incorporated herein in their entirety by reference, to name only a few.

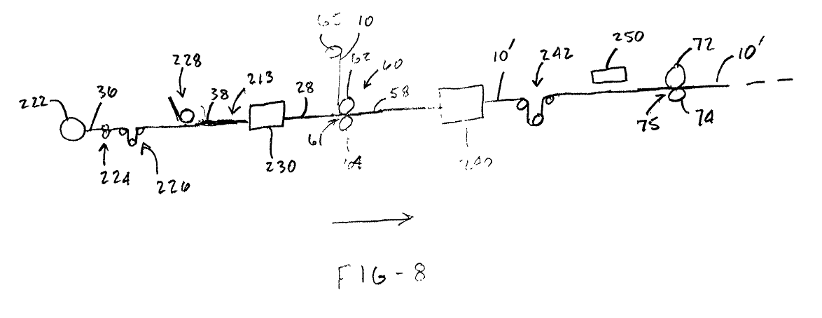

Referring now to FIG. 8 with continued reference to FIG. 5, yet another embodiment of the method of the present invention is illustrated. As indicated in FIG. 8, the substrate 36 is removed from an appropriate unwind roll 222 and fed past a pinch roll structure 224, which is nothing more than the feed structure for pulling the substrate 36 off the unwind roll 222 and pushing it partly through the processing operation. The substrate 36 then passes through a dancer roll structure 226 which is conventional in the art and simply functions to take up slack in the feed of the substrate 36 and aids in tension control. Optionally, the substrate 36 can then pass around an appropriate guider structure (not shown), which maintains the registry of the substrate 36 in a direction transverse to the direction of substrate movement or across machine direction.

The expandable foam layer 38 comprises a resinous composition containing a chemical blowing agent and is applied to a surface of the substrate 36 to form a coated substrate 213. Although not required, the expandable foam layer 38 can have a substantially uniform thickness. The expandable foam layer 38 is coated onto the substrate 36 by any suitable conventional coating apparatus 228 such as a reverse roll coater, a doctor blade, an air knife, or other similar coating apparatus. The coated substrate 213 is then passed through a heating unit generally indicated at 230 which supplies sufficient heat to at least partially gel the thermoplastic resinous coating without decomposing the blowing agent to form the web 28. The term “gel” includes both the partial solvation to the elastomeric point of the resinous composition and complete solvation of the resin or resins with the plasticizer to fuse the layers and top coat. For example, the temperature is raised to between about 275° F. and 325° F. to gel polyvinyl chloride resinous compositions. In one embodiment, the temperature is raised to about 300° F. Any conventional heating unit such as a bank of radiant heaters, an oven, a heated drum, and the like may be utilized.

Next, the hot web 28 enters a lamination section 60 that laminates surface covering 10 to web 28. For high-volume commercial production of surface coverings, such as tiles, the pattern or design of the print and/or gloss layers 18 and 20 may be one that permits tiles to be cut with the pattern or design centered in the tile so that it is in-register with the edges of the tile. Lamination section 60 comprises laminator rolls 62, 64, an optional supply roll 65, and guides 66, 67, and 68. The surface covering 10 is fed either from supply roll 65 or directly from the printing stations 46, through guides 66, 67, and 68 and through laminator rolls 62, 64. Guides 66 and 67 comprise pivot guides for the surface covering 10. The laminator rolls 62, 64 operate at sufficient pressures to provide adherence of the surface covering 10 to the web 28. It has been found that satisfactory adherence and lamination of the surface covering 10 comprising a rigid vinyl film 12 to the web 28 is achieved when the rolls are operated at pressures of about 100 to about 300 psi.

To assist in proper alignment during lamination of the surface covering 10 across machine direction, an edge guidance system (not shown) is used. Moreover, conventional splicing equipment (not shown) may be employed to splice individual rolls of surface covering 10 to form one continuous roll at supply roll 65. The splicing equipment comprises an unwind roll stand, a splice table or auto splice mechanism, and a compensator that allows time to splice the printed design in-register. Alternatively, the printed design may be different and in-register splicing may not be necessary. Also, non-printed films 12 can be spliced and thereafter continuously printed and fed directly to the lamination section as discussed above.

Surface covering 10 and the web 28 next pass through the laminator nip 61 formed by laminator rolls 62, 64 to laminate the surface covering 10 to the expandable foam layer 38 to form a laminate structure 58. The surface covering 10 is laminated to the web 28 with the first side 14 and the print layer 18 thereon, if present, operably adjacent the expandable foam layer 38. As the web 28 enters the laminator nip 61, the web temperature is between about 320° F. to about 350° F. Due to the temperature of the web 28 and the pressure exerted in the laminator nip 61, the surface covering 10 is heated and stretches or elongates to some degree. Because the surface covering 10 has a wrap between about 45 to about 120 degrees on laminator roll 62, tension and the amount of stretch of the surface covering 10, the gloss layer 20, and the print layer 18, if present, thereon, may be controlled by the rotation rate of laminator roll 62. The rate at which the surface covering 10 is applied to the web 28 is defined as the film application rate. Typically, tension on the surface covering 10 is maintained at between about 1.5 to about 2 PLI. The film application rate is controlled by the rate at which laminator roll 62 rotates. Again, by wrapping the surface covering 10 around laminator roll 62, wrinkles are smoothed or “ironed out” of the surface covering 10 to provide a substantially flat laminate structure 58. Should the temperature of the web 28 be insufficiently high to provide sufficient lamination, heaters (not shown), such as infrared heaters, may be employed to raise the web temperature prior to entering the laminator nip 61. The temperature suitable for laminating the surface covering 10 to the web 28 is dependent upon the respective compositions, and may be adjusted accordingly. Further, an adhesive may be disposed between the surface covering 10 and the web 28 to facilitate lamination. Laminator roll 62 can be heated or cooled depending upon film material properties and composition. Typically, the temperature of the laminator roll 62 is maintained at about 90° F. for rigid vinyl films.

If a chemical embossed effect is desired in the foam layer 38, the print layer 18 comprises the chemical embossing agents, such as inhibitors, regulators, retarders, suppressants, accelerators, and the like. As discussed above, the chemical embossing agents may be added to the printing ink composition. Further, the printing ink composition(s) containing the chemical embossing agents may be printed onto the first side 14 of the film 12 in a pattern or design. Such pattern or design, as discussed below, will be placed into the foam layer 38 upon expansion thereof. Alternatively, should no chemically embossed effect be desired, the print layer 18, if present, is void of the chemical embossing agents.

The laminated structure 58 is then passed through a fusion oven 240 to fuse, cure, and expand the foam layer 38 to form surface covering 10′. The fusion oven 240 can be any heating apparatus such as a hot air impingement oven or infra-red heat lamps. Additionally, the fusion oven 240 may heat both surfaces of the laminated structure 58. The fusion oven 240 raises the temperature of the expandable foam layer 38 on the substrate 36 sufficiently high to cause the selective decomposition of the blowing agent contained in the foam layer 38 and to completely solvate and fuse all resinous layers on the substrate 36. If the substrate 36 comprises a resinous composition, the substrate 36 is fused to an adjacent resinous layer, such as the foam layer 38. The cellular foam areas not in contact with or exposed to any inhibitor composition can reach their maximum expansion or blow. The portion of foam layer 38 in contact with any area or composition having a concentration of inhibitor will have little or no foam structure or expansion. However, as indicated above, those foam areas exposed to a portion of the print layer 18 having smaller concentrations of inhibitor can have more foam structure or expansion than those areas having a greater concentration of inhibitor. At this stage, surface covering 10′ may be cooled and wrapped around a roll or punched into tiles.

Additionally, surface covering 10′ may be mechancially embossed. After surface covering 10′ has been tempered by a tempering unit 242 to stabilize the foam layer 38, which assists in preventing de-gassing of the cells of the foam layer 38, surface covering 10′ is heated by a high temperature heater 250 which rapidly heats the film 12 and the gloss layer 20, but does not heat the total surface covering 10′ thickness to a uniform temperature. In this step, the film 12 and the gloss layer 20 are heated to a sufficient degree to allow mechanically embossing thereof without fracture, cracking, or structural failure, such as de-lamination. That is, the film and/or the gloss layer 12 and 20 are heated to a sufficient temperature for a sufficient time in order to soften or even further soften the film and/or gloss layer 12 and 20. The amount of heat to be applied and the duration of such application depends upon, among other things, the temperature of the surface covering 10′ exiting the tempering unit 242, the respective compositions of the film 12 and the gloss layer 20, the respective thicknesses of the film 12 and the gloss layer 20, the speed of the moving surface covering 10′, the color of the printed design on the film 12, and the color of any layers below the film 12. For example, a cross-linked polyurethane film may be heated to a temperature from about 250° F. to about 350° F. To further enhance heating of the film and/or gloss layer 12 and 20, the layers below the film can comprise a resin or contain agents which absorb energy from a desired frequency of the infra-red spectrum.

The high temperature heater 250 can comprises a bank of infra-red heaters. Suitable infra-red heaters are 10.1 kW RADPLANE SERIES 81 infra-red heaters manufactured by Glenro, Inc., Patterson, N.J. The high temperature heater 250 should extend beyond the respective edges of the laminate structure 58 to assist in heating the portions of the film and/or gloss layer 12 and 20 proximate the edges.

From the high temperature heater 250, surface covering 10′ moves directly to the embosser nip 75 and the film and/or gloss layer 12 and 20 are mechanically embossed as described above. Notably, one or more surface textures can be mechanically embossed into the film 12, while no surface texture or one or more surface textures can be mechanically embossed into the gloss layer 20. Likewise, one or more surface textures can be mechanically embossed into the gloss layer 20, while no surface texture is mechanically embossed into the film 12. Each of these surface textures can be the same or different from one another. Also, such surface textures can be mechanically embossed in-register with the design or pattern of the print layer 18, if present, and/or gloss layer 20.

It is certainly within the bounds of the present invention to use several devices with the above discussed embodiments to mechanically emboss different textures onto the film 12 and/or gloss layer 20. Examples of patterns which can be mechanically embossed onto the surface covering 11 include patterns that simulate natural wood, stone, slate, marble, granite, brick, mosaic, tile surfaces, and the natural appearance of other natural products. Further, the techniques of forming webs 28 and laminating the surface covering 10 to the web 28 described above may be employed in any of the embodiments of the present invention.

### EXAMPLES

### Example 1

This example describes a process and an end product comprising a medium gloss composition or varnish printed on a high gloss rigid vinyl film (“RVF”). A matte coating (supplied by Penn Color, No. 29C1053) was diluted with isopropyl acetate until a viscosity of 20 seconds with a #2 Zahn cup was obtained to form the medium gloss composition. The process included single pass printing of an ink composition to form a decorative print layer on one side of a rigid vinyl film and a low gloss coating composition to form a discontinuous gloss layer on the other side of the film. On one side of the film, the decorative print layer was printed thereto by employing multiple printing stations in-register to produce the desired pattern or design. Upon entering the final print station, the film path was directed through the station such that the other side of the film was printed with a medium gloss coating. The medium gloss coating formulation was printed onto the surface of the high gloss rigid vinyl film in pattern areas that correspond to the printing cylinder at 200 fpm. The final coverage of the rigid vinyl film was estimated to be a wet coating application of 0.85 gms/ft² (50 lbs roll 27000 ft). This results in a tack-free film that can be wound. The final film displayed patterned areas with medium and high gloss characteristics.

The medium gloss film composite was laminated and embossed in registration with the decorative pattern onto a tile base web comprising at least a vinyl resin, a plasticizer, and a filler, such as limestone, using a tile belt line. A vinyl mixture sheet or web of about 72-76 mils thick was provided on a conveyor at a temperature of about 300° F. to about 320° F. The belt was heated to allow for good adherence of the web to the belt. The belt line comprising two sets of rolls were used for lamination and embossing processes. The coated film described above was fed through a lamination nip with the gloss layer side contacting the laminator roll. The lamination nip laminated the web and film together. Thereafter, the laminated structure was passed through an embossing nip to emboss the gloss layer side of the film to provide a surface texture. Heat from the belt and web raised the film above the glass transition temperature to facilitate lamination and mechanical embossing. Thereafter, the laminated/embossed surface covering (also referred to as a tile base) was punched into a tile product. In accordance with ASTM Standard D 523-89, “Standard Test Method for Specular Gloss”, the gloss level was measured by a 60 degree gloss meter and is reported in Table 1 below. Additionally, Table 1 summarizes the matte gloss layer resistance to cleaning agents along with wear performance data. The household stain test included applying six stains (e.g., tincture of iodine, shoe polish, hair dye, ball point pen ink, magic marker, and driveway sealer) to samples of the laminated/embossed surface covering, including the film and the gloss layer. The stains remained on the surface covering for 24 hours, and then cleaned. Cleaning agents were placed on the surface for a period of 4 minutes and rinsed off with water. Thereafter, the visual appearance of the film and the gloss layer were compared. No noticeable difference was observed. Also, both the film and the gloss layer were subjected to a Modified Taber Abrasion test, which is an accelerated abrasion resistance test. In this test sample specimens were laid under a leather clad traffic wheel which traveled in a circular motion. The wheel itself rotated along its own axle. Abrasive soils were applied on top of the specimens while the wheel traveled in the circular motion on top of them. After about a 90 minute duration, gloss retention of the specimens were determined with the gloss meter. Higher gloss retention indicated better abrasion resistance. The results of this test coordinate well with actual gloss loss of the product in the field. The low gloss surface coating was found to exhibit good resistance to common household cleaning agents and staining agents and have equal performance to the non-printed RVF areas of the tile product.

TABLE 1
Data Summary of Resistance To Cleaning Agents, Household Stains,
and Abraision of Embossed Tile.

| Sample | 60 degree gloss level |
|---|---|
| Printed Tile | 24 |
| Rigid Vinyl Control Tile | 78 |
| | Results |
| Cleaning Agent | |
| Once and Done Diluted | equal to RVF control tile |
| Once and Done (conc) | equal to RVF control tile |
| New Beginings | equal to RVF control tile |
| Isopropanol | equal to RVF control tile |
| Liberty (floor stripper) | equal to RVF control tile |
| Mineral Spirits | equal to RVF control tile |
| Performance | |
| Household Stains | equal to RVF control tile |
| Modified Taber Abrasion | equal to RVF control tile |

### Example 2

This example describes a process and an end product comprising a low gloss varnish or coating printed in-register with a printed pattern on the film. As described in Example 1, the matte varnish (supplied by Penn Color, No. 29C1057) was diluted with isopropyl acetate until a viscosity of 20 seconds with a #2 Zahn cup was obtained. The low gloss coating was applied as described for Example 1, i.e., the low gloss coating was printed in-register with the print layer pattern or design printed on the opposite side of the film. The line speed during application of the low gloss coating was about 400 fpm. The gloss in-register film composite was laminated and embossed in registration with the gloss and decorative pattern onto a tile base or web using a tile belt line as described in Example 1. The gloss level was measured by a 60 degree gloss meter in accordance with ASTM Standard D 523-89. In the low gloss areas of the gloss layer, the gloss level was between about 6-7. The gloss level in the non-printed areas of the rigid vinyl film was found to be about 78.

Table 2 summarizes the gloss layer resistance to cleaning agents along with wear performance data. Household stains were tested as described in Example 1. Cleaning agents were placed on the surface for a period of 4 minutes and cleaned off with water. The before and after gloss values reflect the effect of each cleaning agent on the gloss layer. The low gloss coating exhibited good resistance to common household cleaning agents as described above and equal performance to the non-printed areas of the rigid vinyl film. The low gloss coating also exhibited equal performance to non-printed areas of the film in heat stability and light stability testing.

TABLE 2
Data Summary of Resistance To Cleaning Agents,
Household Stains, and Abraision.

| Sample | 60 degree gloss level |
|---|---|
| Printed gloss level | 6 |
| Nonprinted gloss level | 78 |
| | Results |
| Cleaning Agent | |
| Once and Done Diluted | equal to non printed RVF areas |
| Once and Done (conc) | equal to non printed RVF areas |
| New Beginings | equal to non printed RVF areas |
| Isopropanol | equal to non printed RVF areas |
| Liberty (floor stripper) | equal to non printed RVF areas |
| Mineral Spirits | equal to non printed RVF areas |
| Performance | |
| Household Stains | equal to non printed RVF areas |
| Modified Taber Abraision | equal to non printed RVF areas |
| Heat Stability 6 wks @ 158 F. | equal to non printed RVF areas |
| Light Stability, 400 hrs Xenon Arc | equal to non printed RVF areas |

### Example 3

This example describes a process and an end product comprising a low gloss varnish or coating printed in-register on a matte film having a printed pattern or design on the opposite side. As described in Example 1, the matte varnish (supplied by Penn Color, No. 29C1057) was diluted with isopropyl acetate until a viscosity of 20 seconds with a #2 Zahn cup was obtained. The low gloss coating was applied as described for Example 1, i.e., the low gloss coating was printed in-register with the printed pattern or design on the opposite side of the film. The line speed during application of the low gloss coating was about 500 fpm. The gloss in-register film composite was laminated and a textures was mechancially embossed in-registration with the gloss and decorative pattern onto a tile base or web using a tile belt line as described in Example 1. The gloss level as measured by a 60 degree gloss meter in accordance with ASTM Standard D 523-89. In the low gloss areas of the gloss layer, the gloss level was about 5. The gloss level in the non-printed areas of the rigid vinyl film was found to be about 21.

Table 3 summarizes the gloss layer resistance to cleaning agents along with wear performance data. Household stains were tested as described in Example 1. Cleaning agents were placed on the surface for a period of 4 minutes and cleaned off with water. The before and after gloss values reflect the effect of each cleaning agent on the gloss layer. The low gloss coating exhibited good resistance to common household cleaning agents as described above and equal performance to the non-printed areas of the rigid vinyl film. The low gloss coating also exhibited equal wear performance to non-printed areas of the film as determined by the Modified Taber Abraison test.

TABLE 3
Data Summary of Resistance To Cleaning Agents, Household Stains,
and Abraision of Embossed Tile.

| Sample | 60 degree gloss level |
|---|---|
| Printed Tile | 5 |
| Nonprinted Rigid Vinyl Areas | 21 |
| | Results |
| Cleaning Agent | |
| Once and Done Diluted | equal to RVF control areas |
| Once and Done (conc) | equal to RVF control areas |
| New Beginnings | equal to RVF control areas |
| Isopropanol | equal to RVF control areas |
| Liberty (floor stripper) | equal to RVF control areas |
| Mineral Spirits | equal to RVF control areas |
| Performance | |
| Household Stains | equal to RVF control areas |
| Abraision Resistance | equal to RVF control areas |

With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawing and described in the specification are intended to be encompassed by the present invention. Further, the various components of the embodiments of the invention may be interchanged to produce further embodiments and these further embodiments are intended to be encompassed by the present invention.

Although the invention has been described in detail for the purpose of illustration, it is understood that such detail is solely for that purpose, and variations can be made therein by those skilled in the art without departing from the spirit and scope of the invention which is defined by the following claims.

What is claimed is:

1. A surface covering comprising:
a film having first and second sides;
a print layer comprising a pattern or design disposed on the first side of the film; and
a discontinuous gloss layer disposed on the second side of the film substantially in-register with at least a portion of the printed pattern or design and having at least one portion thereof comprising a gloss level different from the second side.

2. The surface covering according to claim 1, wherein the print layer is at least partially viewable through the film.

3. The surface covering according to claim 1, wherein the film is a transparent or translucent film.

4. The surface covering according to claim 1, wherein the film comprises a material selected from a polyvinyl chloride, a polyurethane, a polyester, a polyamide, a polyolefin, a polyacrylate, or co-polymers thereof.

5. The surface covering according to claim 1, wherein the discontinuous gloss layer is printed onto the film.

6. The surface covering according to claim 1, wherein the discontinuous gloss layer comprises at least two portions having gloss levels different from one another.

7. The surface covering according to claim 1, wherein the discontinuous gloss layer comprises a binder and a carrier.

8. The surface covering according to claim 7, wherein the binder is selected from an acrylic polymer, a polyurethane, a polyvinyl chloride, an epoxy, or combinations thereof.

9. The surface covering according to claim 7, wherein the carrier is selected from an organic solvent or water.

10. The surface covering according to claim 1, wherein the print layer comprises at least one chemical embossing agent.

11. The surface covering according to claim 1, wherein the film comprises a plurality of film layers which are the same or different from one another.

12. A surface covering comprising:
a film;
a discontinuous gloss layer comprising a pattern or design disposed on one side of the film and having at least one portion thereof comprising a gloss level different from the side upon which the gloss layer is disposed; and
a surface texture mechanically embossed into the film substantially in-register with the pattern or design of the gloss layer.

13. The surface covering according to claim 12, wherein the film is a transparent or translucent film.

14. The surface covering according to claim 12, further comprising a print layer forming a printed design disposed on the other side of the film from the gloss layer.

15. The surface covering according to claim 14, wherein the print layer is at least partially viewable through the film.

16. The surface covering according to claim 14, wherein the print layer comprises at least one inhibitor composition.

17. The surface covering according to claim 13, wherein the film is a transparent or translucent film.

18. The surface covering according to claim 13, wherein the film comprises a material selected from a polyvinyl chloride, a polyurethane, a polyester, a polyamide, a polyolefin, a polyacrylate, or co-polymers thereof.

19. The surface covering according to claim 12, wherein the discontinuous gloss layer is rotogravure printed onto the film.

20. The surface covering according to claim 12, wherein the discontinuous gloss layer comprises at least two portions having gloss levels different from one another.

21. The surface covering according to claim 12, wherein the discontinuous gloss layer comprises a binder and a carrier.

22. The surface covering according to claim 21, wherein the binder is selected from an acrylic polymer, a polyurethane, a polyvinyl chloride, an epoxy, or combinations thereof.

23. The surface covering according to claim 21, wherein the carrier is selected from an organic solvent or water.

24. The surface covering according to claim 12, wherein the film comprises a plurality of film layers which are the same or different from one another.

25. A surface covering comprising:
a web;
a film disposed on the web;
a print layer comprising a printed pattern or design disposed on one side of the film and adjacent the web; and
a discontinuous gloss layer disposed on the other side of the film substantially in-register with at least a portion of the printed design or pattern and having at least one portion thereof comprising a gloss level different from the side thereon.

26. The surface covering according to claim 25, wherein the print layer is at least partially viewable through the film.

27. The surface covering according to claim 25, wherein the film is a transparent or translucent film.

28. The surface covering according to claim 25, wherein the film comprises a material selected from a polyvinyl chloride, a polyurethane, a polyester, a polyamide, a polyolefin, a polyacrylate, or co-polymers thereof.

29. The surface covering according to claim 25, wherein the discontinuous gloss layer is printed onto the film.

30. The surface covering according to claim 25, wherein the discontinuous gloss layer comprises at least two portions having gloss levels different from one another.

31. The surface covering according to claim 25, wherein the discontinuous gloss layer comprises a binder and a carrier.

32. The surface covering according to claim 31, wherein the binder is selected from an acrylic polymer, a polyurethane, a polyvinyl chloride, an epoxy, or combinations thereof.

33. The surface covering according to claim 31, wherein the carrier is selected from an organic solvent or water.

34. The surface covering according to claim 25, wherein the print layer comprises at least one chemical embossing agent.

35. The surface covering according to claim 25, wherein the film comprises a plurality of film layers which are the same or different from one another.

36. The surface covering according to claim 25, wherein the web comprises a foam layer.

37. The surface covering according to claim 36, further comprising another print layer disposed on the foam layer.

38. The surface covering according to claim 37, wherein at least a portion of the another print layer comprises at least one chemical embossing agent.

39. The surface covering according to claim 36, wherein the foam layer has a chemically embossed pattern or design imposed therein.

40. The surface covering according to claim 39, wherein at least a portion of the chemically embossed pattern or design is substantially in-register with a portion of the printed pattern or design.

41. The surface covering according to claim 40, further comprising a mechanically embossed surface texture into the film substantially in-register with the gloss layer.

42. The surface covering according to claim 25, further comprising a mechanically embossed surface texture into the film substantially in-register with the gloss layer.

43. A surface covering comprising:
a film;
a web disposed on one side of the film;
a discontinuous gloss layer comprising a gloss pattern or design disposed on the other side of the film and having at least one gloss level different from the side thereon; and
at least one surface texture mechanically embossed into the film substantially in-register with the gloss pattern or design.

44. The surface covering according to claim 43, wherein the film is a transparent or translucent film.

45. The surface covering according to claim 43, wherein the film comprises a material selected from a polyvinyl chloride, a polyurethane, a polyester, a polyamide, a polyolefin, a polyacrylate, or co-polymers thereof.

46. The surface covering according to claim 43, wherein the discontinuous gloss layer is printed onto the film.

47. The surface covering according to claim 43, wherein the discontinuous gloss layer comprises at least two portions having gloss levels different from one another.

48. The surface covering according to claim 43, wherein the discontinuous gloss layer comprises a binder and a carrier.

49. The surface covering according to claim 48, wherein the binder is selected from an acrylic polymer, a polyurethane, a polyvinyl chloride, an epoxy, or combinations thereof.

50. The surface covering according to claim 48, wherein the carrier is selected from an organic solvent or water.

51. The surface covering according to claim 43, wherein the film comprises a plurality of film layers which are the same or different from one another.

52. The surface covering according to claim 43, wherein the web comprises a foam layer.

53. The surface covering according to claim 52, wherein the foam layer has a chemically embossed pattern or design imposed therein.

54. The surface covering according to claim 53, wherein at least a portion of the chemically embossed pattern or design is substantially in-register with a portion of the gloss pattern or design.

55. The surface covering according to claim 43, wherein the web has a printed design or pattern thereon and is substantially in-register with the gloss pattern or design.

56. The surface covering according to claim 55, wherein at least a portion of the printed design or pattern comprises at least one chemical embossing agent.

57. A method of manufacturing a surface covering comprising:
forming or supplying a film;
applying a print layer comprising a pattern or design on one side of the film;
applying a discontinuous gloss layer on the other side of the film substantially in-register with at least a portion of the printed pattern or design and having at least one portion thereof comprising a gloss level different from the side thereon.

58. The method according to claim 57, further comprising:
forming or supplying a web; and
laminating the film to the web with the print layer proximate the web to form a laminate structure.

59. The method according to claim 57, further comprising:
mechanically embossing at least one surface texture onto the film substantially in-register with the gloss layer; and
setting the at least one surface texture.

60. The method according to claim 58, further comprising:
mechanically embossing at least one surface texture onto the film of the laminate structure substantially in-register with the gloss layer; and
setting the at least one surface texture.

61. The method according to claim 57, wherein at least one portion of the print layer comprises at least one chemical embossing agent.

62. The method according to claim 58, wherein at least one portion of the print layer comprises at least one chemical embossing agent.

63. The method according to claim 58, wherein the web comprises a foamable layer and the method further comprises heating the laminate structure under conditions sufficient to expand the foamable layer to some extent.

64. The method according to claim 62, wherein the web comprises a foamable layer and the method further comprises heating the laminate under conditions sufficient to expand the foamable layer to some extent and chemically emboss therein a pattern or design corresponding to the at least one portion of the print layer comprising the at least one inhibitor composition.

65. The method according to claim 63, further comprising:
mechanically embossing at least one surface texture onto the film of the laminate structure substantially in-register with the gloss layer; and
setting the at least one surface texture.

66. The method according to claim 64, further comprising:
mechanically embossing at least one surface texture onto the film of the laminate structure substantially in-register with the gloss layer; and
setting the at least one surface texture.

67. A method of manufacturing a surface covering comprising:
forming or supplying a film;
applying a discontinuous gloss layer comprising a pattern or design on a side of the film and having at least one portion thereof comprising a gloss level different from the side upon which the gloss layer is disposed;
mechanically embossing at least one surface texture into the film, the gloss layer, or both; and
setting the at least one surface texture.

68. The method according to claim 67, further comprising:
forming or supplying a web; and
laminating the mechanically embossed film to the web to form a laminate structure.

69. The method according to claim 67, wherein the at least one mechanically embossed surface texture is substantially in-register with the pattern or design of the gloss layer.

70. The method according to claim 68, wherein the web comprises a foamable layer and the method further comprises heating the laminate structure under conditions sufficient to expand the foamable layer to some extent.

71. The method according to claim 68, wherein the web comprises a foamable layer and the method further comprises prior to laminating the film to the web:
disposing at least one inhibitor composition in a pattern or design in operable contact with the foamable layer.

72. The method according to claim 71, further comprising:
heating the laminate under conditions sufficient to expand the foamable layer to some extent and chemically emboss therein a pattern or design corresponding to the pattern or design of the at least one inhibitor composition.
